(19) United States
(12) Patent Application Publication
(10) Pub. No.: US 2026/0084098 A1
(43) Pub. Date: Mar. 26, 2026

(54) Separation Membrane Unit And Separation Apparatus

(71) Applicant: SEIKO EPSON CORPORATION, Tokyo (JP)

(72) Inventor: Satoru FUKUI, Chino (JP)

(21) Appl. No.: 19/333,689

(22) Filed: Sep. 19, 2025

(30) Foreign Application Priority Data
Sep. 20, 2024 (JP) 2024-163334

(51) Int. Cl. B01D 53/22; B01D 69/10; B01D 71/70

(52) U.S. Cl. CPC B01D 53/228; B01D 69/108; B01D 71/70; B01D 2053/222; B01D 2256/10; B01D 2257/504; B01D 2325/02832; B01D 2325/02833; B01D 2325/02834

(57) ABSTRACT

Provided is a separation membrane unit that selectively separates carbon dioxide gas from a supply gas containing the carbon dioxide gas and nitrogen gas, the separation membrane unit including:
a porous plate in which a plurality of through holes are formed; and
a separation membrane including a porous body disposed on the first surface of the porous plate and a resin layer disposed on the porous body and selectively permeating the carbon dioxide gas contained in the supply gas toward the porous body,
wherein when the average thickness of the separation membrane is defined as T1, and the average diameter of the plurality of through holes on the first surface is defined as D1, T1/D1≥0.02 is satisfied, and
when the carbon dioxide gas permeability of the separation membrane is defined as A, and the nitrogen gas permeability of the separation membrane is B and the gas permeability of the porous plate is C, 1>(B+C)/(A+C)≥0.8 is satisfied.

The present application is based on, and claims priority from JP Application Serial Number 2024-163334, filed Sep. 20, 2024, the disclosure of which is hereby incorporated by reference herein in its entirety.

### BACKGROUND

### 1. Technical Field

The present disclosure relates to a separation membrane unit and a separation apparatus.

### 2. Related Art

In order to realize carbon neutrality, a technique is considered to capture and recover carbon dioxide gas from the atmosphere. As one such technique, a membrane separation method is known, in which a separation membrane is used to separate target gases such as carbon dioxide gas from mixed gases like the atmosphere.

For example, JP-A-60-75320 discloses a separation membrane including a porous support, a thin film of a siloxane compound disposed on the porous support and having a surface layer plasma-treated with a non-polymerizable gas, and a plasma polymerized film disposed on the thin film. The porous support supports the thin film and the polymerized film. A mixed gas is supplied to the thin film and the polymerized film. In the thin film and the polymerized film, the permeability of the target gas in the mixed gas is higher than the permeability of the non-target gas in the mixed gas. Therefore, the separation membrane can selectively separate the target gas from the mixed gas.

JP-A-60-75320 is an example of the related art.

When a pressure difference exists between the two surfaces constituting the front and back surfaces of the separation membrane, permeation of the target gas in the separation membrane is promoted. However, at this time, the separation membrane may be deformed by the pressure difference. Therefore, the separation membrane is used as a separation membrane unit in combination with, for example, a porous plate supporting the separation membrane. The ratio of the permeability of the target gas to the permeability of the non-target gas through a separation membrane and the like is referred to as the “selectivity ratio”. Depending on the configuration of the porous plate, the selectivity ratio of the separation membrane unit may be significantly lower than the selectivity ratio of the separation membrane.

### SUMMARY

A separation membrane unit according to an application example of the present disclosure is a separation membrane unit that selectively separates carbon dioxide gas from a supply gas containing the carbon dioxide gas and nitrogen gas, the separation membrane unit including:
a porous plate having a first surface and a second surface opposite to each other, and in which a plurality of through holes extending from the first surface toward the second surface are formed;
and a separation membrane including a porous body disposed on the first surface and a resin layer disposed on the porous body and selectively permeating the carbon dioxide gas contained in the supply gas toward the porous wherein when the carbon dioxide gas permeability body, of the separation membrane is defined as A, 500,000 GPU≥A≥1,000 GPU is satisfied,
when the average thickness of the separation membrane is defined as T1, 200 μm≥T1≥10 μm is satisfied;
when the average diameter of the plurality of through holes on the first surface is defined as D1, T1/D1≥0.02 is satisfied, and
when the nitrogen gas permeability of the separation membrane is defined as B and the gas permeability of the porous plate is defined as C, 1>(B+C)/(A+C)≥0.8 is satisfied.

A separation apparatus according to an application example of the present disclosure is mounted with the separation membrane unit described above.

### BRIEF DESCRIPTION OF THE DRAWINGS

FIG. 1 is a cross-sectional view illustrating a separation apparatus according to an embodiment.

FIG. 2 is an enlarged cross-sectional view of a part of FIG. 1.

FIG. 3 is a top view illustrating the porous plate of FIG. 1.

FIG. 4 is a schematic view illustrating the relationship between the deflection of the separation membrane and the diameter of the through hole in the first surface of the porous plate.

FIG. 5 is a schematic view illustrating a method for measuring gas permeability of the porous plate.

FIG. 6 is a cross-sectional view illustrating a separation membrane unit according to Modification 1.

FIG. 7 is a cross-sectional view illustrating a separation membrane unit according to Modification 2.

FIG. 8 is Table 1 showing the configurations and evaluation results of the separation membrane units of Examples 1 to 5 separation membrane units of Comparative Examples 1 to 4.

FIG. 9 is a Table 2 showing the configurations and evaluation results of the separation membrane unit of Examples 6 and 7, and Comparative Example 5.

### DESCRIPTION OF EMBODIMENTS

Hereinafter, embodiments and modifications of the present disclosure will be described with reference to the drawings. Note that the following description is not intended to limit the technical scope or the meaning of terms described in the claims. In addition, dimensional ratios in the drawings are exaggerated for convenience of description, and may be different from actual ratios.

### EMBODIMENTS

First, a separation apparatus 100 according to the embodiment will be described.

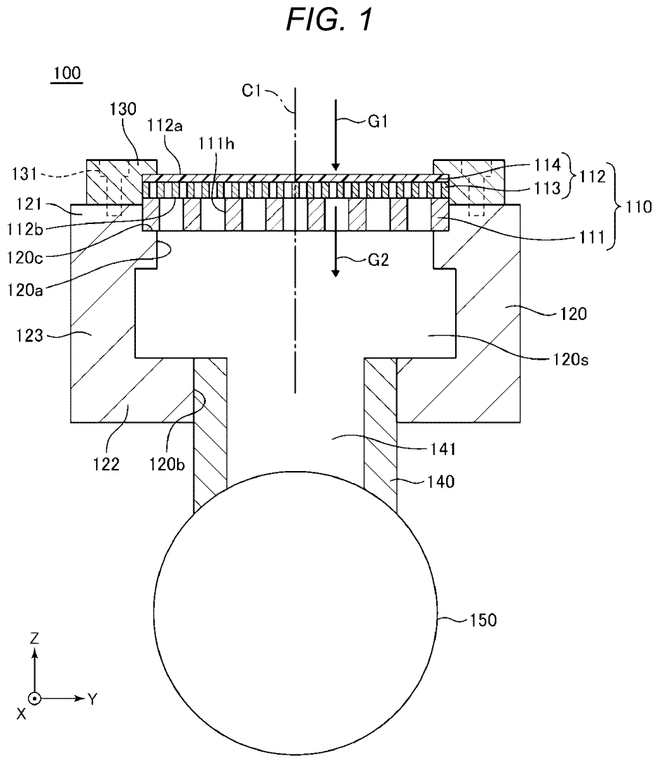

FIG. 1 is a cross-sectional view illustrating the separation apparatus 100 according to the present embodiment.

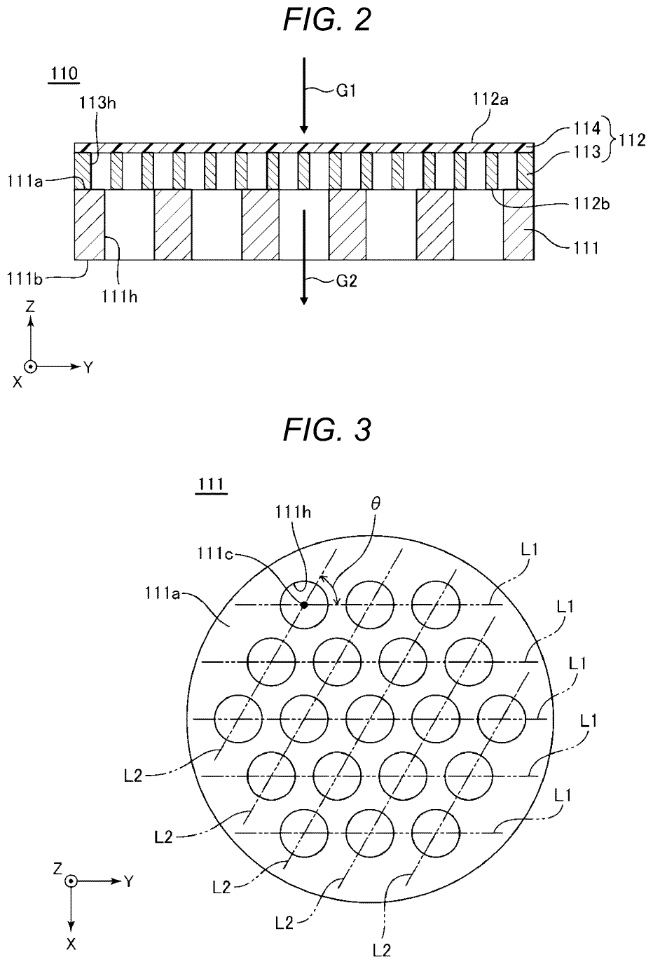

FIG. 2 is an enlarged cross-sectional view of a part of FIG. 1.

In FIG. 1, the pump 150, which will be described later, is schematically illustrated in a circular shape. In addition, in FIG. 1, the accommodation portion 120 and the pipe 140, which will be described later, are illustrated by end surfaces rather than cross-sections.

In the drawings of the present embodiments, an X axis, a Y axis, and a Z axis are set as three axes orthogonal to each other. Each axis is indicated by an arrow, and a tip side of the arrow is defined as “positive”, and a base end side of the arrow is defined as “negative”. In the following description, for example, an “X axis direction” includes both a positive direction and a negative direction of the X axis. The same applies to a Y axis direction and a Z axis direction. In the following description, in particular, the positive side of the Z axis is defined as “upper”, and the negative side of the Z axis is defined as “lower”. The Z axis is not required to be parallel to a vertical axis, and may cross the vertical axis. Hereinafter, the uppermost end of each member is referred to as an “upper end”, and a certain range from the upper end toward the lower side in each member is referred to as an “upper end portion”. Similarly, the lowermost end of each member is referred to as a “lower end”, and a certain range from the lower toward the upper side in each member is referred to as a “lower end portion”.

Referring to FIG. 1, the separation apparatus 100 includes a separation membrane unit 110, an accommodation portion 120, a pipe 140, and a pump 150.

The separation membrane unit 110 includes a porous plate 111 in which a plurality of through holes 111h are formed, and a separation membrane 112 disposed on the porous plate 111. A mixed gas is supplied to the separation membrane 112. Hereinafter, the mixed gas supplied to the separation membrane 112 is also referred to as a “supply gas G1”. The supply gas G1 includes carbon dioxide gas and nitrogen gas. The supply gas G1 is not particularly limited, and is, for example, the atmosphere. In the separation membrane 112, the carbon dioxide gas permeability is higher than the nitrogen gas permeability. Therefore, the separation membrane 112 can selectively permeate the carbon dioxide gas contained in the supply gas G1 toward the porous plate 111. Thus, the separation membrane 112 can selectively separate the carbon dioxide gas from the supply gas G1. Herein, “selectively permeating or separating carbon dioxide gas” does not mean that only carbon dioxide gas is permeated or separated, and that nitrogen gas is not permeated or separated at all. “Selectively permeating or separating carbon dioxide gas” means that carbon dioxide gas is permeated or separated at a higher permeability than nitrogen gas, that is, carbon dioxide gas is permeated or separated more preferentially than nitrogen gas.

The gas that has permeated through the separation membrane 112 passes through the plurality of through holes 111h in the porous plate 111. Hereinafter, the gas that has permeated through the separation membrane 112 is also referred to as the “permeate gas G2”. The separation membrane 112 permeates nitrogen gas while preferentially permeating the carbon dioxide gas. Therefore, the permeate gas G2 includes carbon dioxide gas and nitrogen gas.

The accommodation portion 120 holds the separation membrane unit 110. An accommodation space 120s for accommodating the permeate gas G2 permeated through the porous plate 111 is formed in the accommodation portion 120.

The pipe 140 is coupled to the accommodation portion 120. The pump 150 reduces the pressure in the accommodation space 120s via the pipe 140. Accordingly, the pressure applied to the surface 112a to which the supply gas G1 is supplied in the separation membrane 112 is higher than the pressure applied to the surface 112b in contact with the porous plate 111 in the separation membrane 112. As a result, carbon dioxide gas permeates more readily through the separation membrane 112. The permeate gas G2 in the accommodation space 120s is drawn by the pump 150 and recovered.

In the present embodiment, the separation apparatus 100 further includes a fixing member 130 that fixes the separation membrane unit 110 to the accommodation portion 120. Hereinafter, each unit of the separation apparatus 100 will be described in detail.

First, the porous plate 111 will be described.

FIG. 3 is a top view illustrating the porous plate 111 of FIG. 1.

As illustrated in FIG. 2, in the present embodiment, the porous plate 111 has a flat plate shape substantially parallel to the X-Y plane. As illustrated in FIG. 3, the shape of the porous plate 111 when viewed from the top is, for example, circular. As illustrated in FIG. 2, the surface of the porous plate 111 has a first surface 111a and a second surface 111b opposite to each other. The first surface 111a corresponds to an upper surface, and is a surface on which the separation membrane 112 is disposed. The second surface 111b corresponds to a lower surface. The rigidity of the porous plate 111 is higher than the rigidity of the separation membrane 112. Therefore, the porous plate 111 can favorably support the separation membrane 112.

The through holes 111h formed in the porous plate 111 extend from the first surface 111a toward the second surface 111b. That is, each through hole 111h penetrates the porous plate 111 in the thickness direction. The thickness direction of the porous plate 111 coincides with the Z axis direction in the present embodiment.

As illustrated in FIG. 3, the plurality of through holes 111h are formed so as to be dispersed on the X-Y plane except for the outer circumferential portion of the porous plate 111 in the present embodiment. Specifically, when viewed from the top, centers 111c of the plurality of through holes 111h are located on intersections of the plurality of virtual first straight lines L1 and the plurality of second straight lines L2. The plurality of first straight lines L1 are parallel to each other. The plurality of first straight lines L1 are arranged at equal intervals in a direction orthogonal to the direction in which the first straight line L1 extends. The plurality of second straight lines L2 are parallel to each other and intersect the plurality of first straight lines L1. The plurality of second straight lines L2 are arranged at equal intervals in a direction orthogonal to the extending direction of the second straight line L2. An angle θ formed by the first straight line L1 and the second straight line L2 is smaller than 90 degrees. However, the arrangement of the plurality of through holes is not limited to the above. For example, the plurality of through holes may be formed also in the outer circumferential portion of the porous plate, or the angle formed by the first straight line and the second straight line may be 90 degrees.

The shape of each through hole 111h when viewed from the top is for example, circular. However, the shape of each through hole 111h when viewed from the top may be a polygon such as a hexagon, an oval, an ellipse, or the like. In the present embodiment, the diameter of each through hole 111h is substantially constant without changing in the thickness direction of the porous plate 111. When viewed from the top, when the shape of the through hole is other than circular, the diameter of a circumscribed circle of the through hole is defined as the diameter of the through hole.

An average value of diameters of the plurality of through holes 111h in the first surface 111a is defined as an “average diameter D1”. Although not particularly limited, it is preferable that 5 mm≥D1≥0.1 mm, more preferably 4 mm≥D1≥0.1 mm, and still more preferably 2 mm≥D1≥0.1 mm. By setting the average diameter D1 to be equal to or greater than the above lower limit value, the gas permeability of the porous plate 111 can be improved. By setting the average diameter D1 to be equal to or less than the above upper limit value, the rigidity of the porous plate 111 can be improved.

An average value of thicknesses at a plurality of positions on the X-Y plane of the porous plate 111 is defined as an “average thickness T2” of the porous plate 111. Although not particularly limited, it is preferable that 30 mm≥T2≥0.05 mm, more preferably 30 mm≥T2≥0.07 mm, and still more preferably 1 mm≥T2≥0.07 mm. By setting the average thickness T2 of the porous plate 111 to be equal to or greater than the above lower limit value, the rigidity of the porous plate 111 can be improved. Accordingly, deformation of the porous plate 111 when the pump 150 reduces the pressure in the accommodation space 120s can be suppressed. In addition, by setting the average thickness T2 of the porous plate 111 to be equal to or less than the above upper limit value, it is possible to reduce the pressure loss when the permeate gas G2 flows through each through hole 111h in the porous plate 111. As a result, the gas permeability of the porous plate 111 can be increased.

When viewed from the top, the ratio of the total area of the plurality of through holes 111h to the effective area of the separation membrane 112 is referred to as the “opening ratio” of the porous plate 111. The “effective area of the separation membrane 112” means the area of a region of the upper surface of the separation membrane 112 which is exposed from other components such as the fixing member 130 and to which the supply gas G1 is supplied to the separation membrane 112. The “total area of the plurality of through holes 111h” is the total area of the plurality of through holes 111h located within the range of the effective area of the separation membrane 112 when viewed from the top. The opening ratio of the porous plate 111 is preferably 5% or more and 95% or less, more preferably 20% or more and 95% or less, and still more preferably 70% or more and 95% or less. By setting the opening ratio of the porous plate 111 to be equal to or greater than the above lower limit value, the gas permeability of the porous plate 111 can be improved. By setting the opening ratio of the porous plate 111 to be equal to or less than the above upper limit value, the rigidity of the porous plate 111 can be improved. Accordingly, deformation of the porous plate 111 when the pump 150 reduces the pressure in the accommodation space 120s can be suppressed.

The arithmetic average roughness of the surface on which the through holes 111h in the porous plate 111 are formed is defined as the “surface roughness” of the porous plate 111. The surface roughness of the porous plate 111 is not particularly limited, but is preferably 0.012 μm or more and 6.3 μm or less, more preferably 0.05 μm or more and 6.3 μm or less, and still more preferably 0.1 μm or more and 1.6 μm or less. By setting the surface roughness of the porous plate 111 to be equal to or less than the above upper limit value, the pressure loss when the permeate gas G2 flows through the plurality of through holes 111h can be reduced. By setting the surface roughness to be equal to or greater than the above lower limit value, the manufacturing cost of the porous plate 111 can be suppressed. The surface roughness is measured according to JIS B 0601:2013 using a contact or non-contact surface roughness measuring instrument.

The material of the porous plate 111 is a ceramic material, a metal material, or the like. Examples of the ceramic material include alumina. Examples of the metal material include stainless steel, titanium, and aluminum.

Next, the separation membrane 112 will be described.

As illustrated in FIG. 2, the separation membrane 112 includes a porous body 113 disposed on the first surface 111a of the porous plate 111, and a resin layer 114 disposed on the porous body 113.

In the present embodiment, the porous body 113 is formed of a porous layer in which a plurality of pores 113h are formed. The porous body 113 extends in the X axis direction and the Y axis direction. In the present embodiment, the porous body 113 covers substantially the entire first surface 111a of the porous plate 111. Therefore, the shape of the porous body 113 when viewed from the top is circular in the present embodiment. Here, the shape of the porous body when viewed from the top is not limited to the above, and may be, for example, a polygon such as a quadrangle.

Each of the pores 113h penetrates the porous body 113 in the thickness direction. The thickness direction of the porous body 113 coincides with the Z axis direction in the present embodiment. The plurality of pores 113h are formed to be dispersed on the X-Y plane. Herein, the diameter of the inscribed circle of the pore 113h is defined as the “diameter” of the hole 113h.

An average value of the diameters of the plurality of pores 113h is defined as the “average diameter” of the pores 113h. The average diameter of the pores 113h is smaller than the average diameter D1 of the porous plate 111. The average diameter of the pores 113h is preferably 5 nm or more and 1,000 nm or less, more preferably 50 nm or more and 500 nm or less, and even more preferably 50 nm or more and 200 nm or less. The average diameter of the pores 113h can be measured by a through hole diameter evaluation device after removing the resin layer 114 from the separation membrane 112 and the single porous body 113 is taken out. Examples of the through hole diameter evaluation device include a perm porometer manufactured by PMI. By setting the average diameter of the pores 113h to be equal to or greater than the above lower limit value, the carbon dioxide gas permeability of the porous body 113 can be improved. In addition, by setting the average diameter of the pores 113h to be equal to or less than the above upper limit value, mechanical strength of the separation membrane 112 can be improved.

Examples of materials of the porous body 113 include a polymer material, a ceramic material, or a metal material. Examples of the polymer material include polyolefin resins such as polyethylene and polypropylene, fluorine-containing resins such as polytetrafluoroethylene, polyvinyl fluoride, and polyvinylidene fluoride, polystyrene, cellulose, cellulose acetate, polyurethane, polyacrylonitrile, polyphenylene oxide, polysulfone, polyethersulfone, polyimide, polyaramid, and nylon. Examples of the ceramic material include alumina, cordierite, mullite, silicon carbide, and zirconia. Examples of the metal material include stainless steel.

However, the configuration of the porous body is not limited to the above. For example, the porous body may be made of a plurality of laminated porous layers.

The resin layer 114 is substantially a dense membrane and has a good affinity for carbon dioxide molecules. Therefore, in the resin layer 114, the carbon dioxide gas permeability is higher than the nitrogen gas permeability. Accordingly, the resin layer 114 selectively permeates the carbon dioxide gas in the supply gas G1. In the present embodiment, the resin layer 114 covers substantially an entire upper surface of the porous body 113. Therefore, in the present embodiment, the shape of the resin layer 114 when viewed from the top is circular, similarly to the porous body 113. However, the shape of the resin layer 114 when viewed from the top is not limited to the above, and may be, for example, a polygon such as a quadrangle.

An average value of thicknesses of the resin layer 114 at a plurality of positions on the X-Y plane is defined as an “average thickness” of the resin layer 114. In the present embodiment, the average thickness of the resin layer 114 is smaller than the average thickness of the porous body 113. The average thickness of the resin layer 114 is not particularly limited, and is preferably 5 nm or more and 1,000 nm or less, more preferably 10 nm or more and 800 nm or less, and still more preferably 30 nm or more and 500 nm or less. The average thickness of the resin layer 114 can be measured by, for example, a scanning electron microscope (SEM). By setting the average thickness of the resin layer 114 to be equal to or greater than the above lower limit value, it is possible to suppress occurrence of defects or damage in the resin layer 114. By setting the average thickness of the resin layer 114 to be equal to or less than the above upper limit value, the carbon dioxide gas permeability of the separation membrane 112 can be improved.

The material of the resin layer 114 is a polymer material. Examples of the polymer material include polyolefin resins such as polyethylene and polypropylene, fluorine-containing resins such as polytetrafluoroethylene, polyvinyl fluoride, and polyvinylidene fluoride, polystyrene, cellulose, cellulose acetate, polyurethane, polyacrylonitrile, polyphenylene oxide, polysulfone, polyethersulfone, polyimide, polyaramid, organopolysiloxane, polyethylene terephthalate (PET), polyacetal (POM), and polylactic acid (PLA). The constituent material for the resin layer 114 may be one of the polymer materials or a composite material of two or more of the polymer materials. The polymer material may be a thermoplastic resin, a thermosetting resin, or a photocurable resin.

Among these, the organopolysiloxane is preferably used as the constituent material of the resin layer 114. The organopolysiloxane has a good affinity for carbon dioxide molecules.

An average value of thicknesses at a plurality of positions on the X-Y plane of the separation membrane 112 is defined as an “average thickness T1” of the separation membrane 112. 200 μm≥T1≥10 μm is satisfied. Although not particularly limited, it is preferable that 150 μm≥T1≥10 μm is satisfied, and more preferably 100 μm≥T1≥10 μm is satisfied. The average thickness T1 can also be measured by, for example, SEM or the like. By setting the average thickness T1 of the separation membrane 112 to be equal to or greater than the above lower limit value, the mechanical strength of the separation membrane 112 can be improved. By setting the average thickness T1 of the separation membrane 112 to be equal to or less than the above upper limit, the carbon dioxide gas permeability of the separation membrane 112 can be improved.

Next, the accommodation portion 120 will be described.

As illustrated in FIG. 1, the accommodation portion 120 is a chamber. In the present embodiment, the accommodation portion 120 has a hollow cylindrical shape. A central axis C1 of the accommodation portion 120 extends in the Z axis direction. In the present embodiment, the accommodation space 120s has a cylindrical shape. Specifically, the accommodation portion 120 includes an upper wall 121 substantially parallel to the X-Y plane, a lower wall 122 located below the upper wall 121 and substantially parallel to the X-Y plane, and a side wall 123 located between the upper wall 121 and the lower wall 122 and extending in the Z axis direction. An inlet 120a into which the permeate gas G2 flows is formed in the upper wall 121. An outlet 120b through which the permeate gas G2 flows out is formed in the lower wall 122. The side wall 123 has a cylindrical shape.

The inlet 120a penetrates the upper wall 121 in the thickness direction substantially at the center when viewed from the top. The shape of the inlet 120a when viewed from the top is, for example, circular. A step 120c in which the porous plate 111 can be disposed is formed around the inlet 120a on the upper surface of the upper wall 121. The porous plate 111 is disposed on the step 120c so as to cover the inlet 120a.

The outlet 120b penetrates the lower wall 122 in the thickness direction substantially at the center when viewed from the top. The shape of the outlet 120b when viewed from the top is, for example, substantially similar to the outer shape of the pipe 140 described later, and is circular.

However, the specific shape of the accommodation portion is not limited to the above. For example, the accommodation portion may have a hollow rectangular parallelepiped shape. Also, for example, it is not necessary to form a step for disposing the porous plate on the upper wall. The shapes of the inlet, the accommodation space, and the outlet are not limited to those described above. For example, the shape of the inlet and the outlet when viewed from the top may be a polygon such as a quadrangle. Further, for example, the shape of the accommodation space may be a rectangular parallelepiped. Positions of the inlet and the outlet are not limited to the above as long as the permeated gas can flow into the accommodation space and the permeate gas flowing into the accommodation space can be discharged to the pipe.

Next, the fixing member 130 will be described.

The shape of the fixing member 130 is a frame shape in the present embodiment. The fixing member 130 is fixed to the accommodation portion 120 by a plurality of fixing tools 131 such as screws or bolts while covering outer circumferential portions of the separation membrane 112 and the porous plate 111 from above. Thus, the accommodation portion 120 holds the separation membrane 112 and the porous plate 111. At this time, although not illustrated, it is preferable to dispose a seal member so that gas does not leak from the gap between the separation membrane 112 and the fixing member 130, between the fixing member 130 and the accommodation portion 120, or the like. However, the specific shape of the fixing member is not limited to the above as long as the separation membrane unit can be fixed to the accommodation portion. The method for fixing the separation membrane unit to the accommodation portion is not limited to the method using the fixing member.

Next, the pipe 140 will be described.

The pipe 140 has a cylindrical shape and extends linearly in the Z axis direction in the present embodiment. Therefore, an internal space 141 of the pipe 140 also extends linearly in the Z axis direction. The pipe 140 is coupled to the accommodation portion 120 in a state where the upper end portion of the pipe 140 is inserted into the outlet 120b of the accommodation portion 120. The internal space 141 of the pipe 140 communicates with the accommodation space 120s. However, a specific shape of the pipe is not limited to the above. For example, the pipe may be bent. Further, instead of inserting the upper end portion of the pipe into the outlet, the pipe may be coupled to the accommodation portion in a state where the upper end of the pipe is in contact with the lower surface of the lower wall of the accommodation portion.

Next, the pump 150 will be described.

The pump 150 is coupled to a lower end portion of the pipe 140. The pump 150 reduces the pressure in the accommodation space 120s via the pipe 140. The pump 150 is, for example, a dry vacuum pump. However, the type of the pump is not particularly limited as long as the accommodation space can be decompressed.

Next, the flows of the supply gas G1 and the permeate gas G2 will be described.

First, the supply gas G1 is supplied to the separation membrane 112. In a state where the accommodation space 120s is reduced in pressure by the pump 150, part of the carbon dioxide gas and the nitrogen gas in the supply gas G1 permeates the separation membrane 112. The permeate gas G2, containing carbon dioxide gas and nitrogen gases that have permeated the separation membrane 112, passes through the plurality of through holes 111h in the porous plate 111. Next, the permeate gas G2 flows into the internal space 141 of the pipe 140 via the accommodation space 120s. Next, the permeate gas G2 is drawn by the pump 150 and recovered.

Although the separation apparatus 100 mounted with the separation membrane unit 110 has been described above, the configuration of the separation apparatus is not limited to the above. For example, a plurality of separation membrane units may be mounted on one separation apparatus. In this case, one accommodation portion may hold a plurality of separation membrane units, or the separation apparatus may be provided with a number of accommodation portions corresponding to the number of separation membrane units.

Next, parameters of the separation membrane unit 110 will be described.

The carbon dioxide gas permeability of the separation membrane 112 is defined as A. The nitrogen gas permeability of the separation membrane 112 is defined as B. The term “permeability” refers to the amount of gas that permeates per unit area, unit time, and unit pressure. The carbon dioxide gas permeability A and the nitrogen gas permeability B are each measured using a gas permeability measuring apparatus according to the gas permeability test method (Part 1: differential pressure method) specified in JIS K 7126-1:2006. Examples of the gas permeability measuring apparatus include GTR-11A/31A manufactured by GTR TEC Corporation. The unit of the carbon dioxide gas permeability A and the nitrogen gas permeability B is, for example, a GPU. The 1 GPU is 3.35×10⁻¹⁰ mol·m⁻²·s⁻¹·Pa⁻¹. Thus, the carbon dioxide gas permeability A and the nitrogen gas permeability B show the performance of the single separation membrane 112 in a state where the separation membrane 112 is not incorporated into the separation membrane unit 110 and the separation apparatus 100.

In the present embodiment, 500,000 GPU≥A≥1,000 GPU is satisfied. Further, it is preferable that 400,000 GPU≥A≥5,000 GPU, and more preferably that 300,000 GPU≥A≥7,000 GPU. By setting the carbon dioxide gas permeability A to be equal to or greater than the above lower limit value, the amount of energy required for separation can be reduced. The amount of energy required for separation is specifically the difference between the pressure applied to the surface 112a to which the supply gas G1 is supplied in the separation membrane 112 and the pressure applied to the surface 112b in contact with the porous plate 111 in the separation membrane 112. In the separation membrane 112 including the resin layer 114 made of a polymer material, the carbon dioxide gas permeability A and the selectivity ratio of the separation membrane 112 are in a trade-off relationship. Therefore, when the carbon dioxide gas permeability A exceeds above upper limit, it may be difficult to maintain the balance with the selectivity ratio of the separation membrane 112.

The carbon dioxide gas permeability A of the separation membrane 112 can be controlled by adjusting the material of the resin layer 114, the average thickness of the resin layer 114, the average diameter of the pores 113h of the porous body 113, the average thickness T1 of the separation membrane 112, and the like. Specifically, the carbon dioxide gas permeability A of the separation membrane 112 can be increased by using a material having high affinity for carbon dioxide molecules as the material of the resin layer 114. In addition, by reducing the average thickness of the resin layer 114, the carbon dioxide gas permeability A of the separation membrane 112 can be increased. Further, by using a material having a high gas permeability for the material of the porous body 113, the carbon dioxide gas permeability A of the separation membrane 112 can be increased. Further, by increasing the average diameter of the pores 113h of the porous body 113, the carbon dioxide gas permeability A of the separation membrane 112 can be increased. In addition, by reducing the average thickness T1 of the separation membrane 112, the carbon dioxide gas permeability A of the separation membrane 112 can be increased.

As illustrated (Formula 1) below, the ratio of the carbon dioxide gas permeability A to the nitrogen gas permeability B is defined as the selectivity ratio of the separation membrane 112.

$$Selectivity ratio of separation membrane 112 = A / B \qquad ( Formula 1 )$$

Hereinafter, the selectivity ratio of the separation membrane 112 is also referred to as a “selectivity ratio A/B”. The carbon dioxide gas permeability A is greater than the nitrogen gas permeability B. Therefore, the selectivity ratio A/B of the separation membrane 112 is greater than 1.

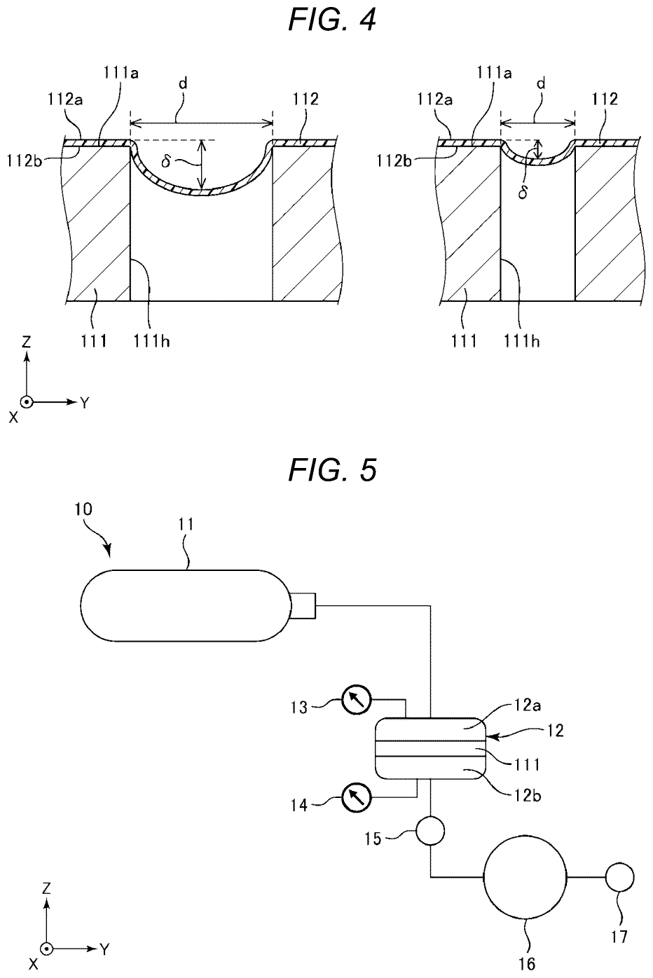

FIG. 4 is a schematic view illustrating the relationship between the deflection δ of the separation membrane 112 and the diameter d of the through hole 111h in the first surface 111a of the porous plate 111.

In a state where the accommodation space 120s is reduced in pressure by the pump 150, the pressure applied to the surface 112a to which the supply gas G1 is supplied in the separation membrane 112 is higher than the pressure applied to the surface 112b in contact with the porous plate 111 in the separation membrane 112. Therefore, a force is applied to the separation membrane 112 in the direction from the separation membrane 112 to the porous plate 111, that is, in the downward direction. Thus, depending on the rigidity and pressure difference of the separation membrane 112, as illustrated in FIG. 4, the separation membrane 112 deflects downward into the through hole 111h. The larger the diameter d of the through hole 111h on the first surface 111a of the porous plate 111, the greater the deflection δ of the separation membrane 112.

Furthermore, the smaller the thickness of the separation membrane 112, the lower the rigidity of the separation membrane 112. The lower the rigidity of the separation membrane 112, the greater the deflection δ of the separation membrane 112. The more the separation membrane 112 deflects, the more prone the separation membrane 112 is to damage. Therefore, it can be seen that it is important to adjust the average thickness T1 of the separation membrane 112 and the average diameter D1 of the plurality of through holes 111h in the first surface 111a of the porous plate 111 in order to suppress damage to the separation membrane 112. As will be described in detail later, according to the investigation by the present disclosers, damage to the separation membrane 112 can be suppressed when the average thickness T1 of the separation membrane 112 and the average diameter D1 of the plurality of through holes 111h satisfy (Formula 2) below.

$$T 1 / D 1 \geq 0.02 \qquad ( Formula 2 )$$

From the above description, it can be seen that the smaller the average diameter D1 of the plurality of through holes 111h, the easier it is to suppress damage to the separation membrane 112. However, the smaller the average diameter D1 of the plurality of through holes 111h, the lower the gas permeability of the porous plate 111. The gas permeability of the porous plate 111 also changes with other configurations such as the average thickness T2 and the opening ratio of the porous plate 111. When the gas permeability of the porous plate 111 decreases, the selectivity ratio of the separation membrane unit 110 decreases with respect to the selectivity ratio A/B of the separation membrane 112. Therefore, the present disclosers have considered that, in order to realize the separation membrane unit 110 having a good selectivity ratio with respect to the selectivity ratio A/B of the separation membrane 112 while suppressing damage to the separation membrane 112, it is important to consider not only T1/D1 but also the gas permeability of the porous plate 111.

FIG. 5 is a schematic view illustrating a method for measuring gas permeability of the porous plate 111. In the drawing, some pipes are simplified and indicated by solid lines.

The gas permeability measuring apparatus 10 is used to measure the gas permeability of the porous plate 111. The gas permeability measuring apparatus 10 includes a gas supply unit 11, a chamber 12, an upstream pressure gauge 13, a downstream pressure gauge 14, a flowmeter 15, a vacuum pump 16, and a concentration meter 17. First, the porous plate 111 is disposed in the chamber 12. The internal space of chamber 12 is divided into an upstream space 12a and a downstream space 12b by a porous plate 111 serving as a boundary. The gas supply unit 11 and the upstream space 12a are coupled by a pipe or the like. The downstream space 12b and the vacuum pump 16 are coupled by piping or the like.

The gas supply unit 11 includes, for example, a gas tank and a mass flow controller. The gas supplied by the gas supply unit 11 is a gas which is a main component of the permeate gas G2. In the present embodiment, the supply gas G1 is the atmosphere, and the concentration and the partial pressure of the nitrogen gas in the supply gas G1 are much higher than the concentration and the partial pressure of the carbon dioxide gas. Therefore, although the carbon dioxide gas permeability A of the separation membrane 112 is higher than the nitrogen gas permeability B, the permeation amount of the nitrogen gas is greater than the permeation amount of the carbon dioxide gas. That is, in the present embodiment, the gas of the main component of the permeate gas G2 is nitrogen gas. Accordingly, the gas supply unit 11 supplies nitrogen gas as a single gas. However, when the supply gas is not the atmosphere and the concentration and the partial pressure of the carbon dioxide gas in the supply gas are higher than the concentration and the partial pressure of the nitrogen gas, the gas of the main component of the permeate gas is the carbon dioxide gas. In this case, the gas supply unit may supply the carbon dioxide gas.

When the gas permeability of the porous plate 111 is measured, first, the internal space of the chamber 12 is reduced in pressure to 3 kPa using the vacuum pump 16. Next, the gas supply unit 11 supplies a gas at 103 kPa to the upstream space 12a of the chamber 12. As a result, the gas starts to flow through the plurality of through holes 111h in the porous plate 111. Then, the vacuum pump 16 draws in the gas that has passed through the porous plate 111. At this time, the absolute pressure of the gas supplied to the porous plate 111 is measured by the upstream pressure gauge 13. The absolute pressure of the gas passing through the porous plate 111 is measured by the downstream pressure gauge 14. The volume of the gas passing through the porous plate 111 per unit time is measured by the flowmeter 15. The concentration meter 17 measures the amount of substance per unit volume of the gas recovered by the vacuum pump 16. Other test conditions such as the test temperature are in accordance with JIS K 7126-1:2006 as long as possible.

Immediately after the gas is supplied, the flow rate and the absolute pressure of the gas passing through the porous plate 111 gradually increase, and thereafter, the flow rate and the absolute pressure become substantially constant. The upstream absolute pressure on the porous plate 111 in the stable state is defined as P3, and the downstream absolute pressure on the porous plate 111 is defined as P4. In addition, from the volume of the gas per unit time and the amount of the substance per unit volume of the gas that have passed through the porous plate 111 in the stable state, the amount of substance per unit time of the gas that has passed through the porous plate 111 is calculated. The amount of substance per unit time is defined as n. The area of the porous plate 111 to which the gas is supplied, that is, the area of the upper surface of the porous plate 111 is defined as s1.

The gas permeability of the porous plate 111 is defined as C. The gas permeability C of the porous plate 111 can be calculated by substituting the respective above values into (Formula 3) below.

$$C = n / \{ ( P 3 - P 4 ) \cdot s 1 \} \qquad ( Formula 3 )$$

The unit of the above gas permeability C is mol·m⁻²·s⁻¹·Pa⁻¹. The gas permeability C is used together with the carbon dioxide gas permeability A and the nitrogen gas permeability B for calculation of parameters to be described later. Therefore, the unit of the gas permeability C needs to be aligned with the unit of the carbon dioxide gas permeability A and the nitrogen gas permeability B. When the GPU is used as the unit of the carbon dioxide gas permeability A and the nitrogen gas permeability B, the value calculated by (Formula 3) may be divided by 3.35×10⁻¹⁰. Since the gas permeability C is measured using the gas of the main component of the permeate gas G2, the gas permeability C can be regarded as the gas permeability of the permeate gas G2 of the porous plate 111. The gas permeability measuring apparatus 10 may also be used to measure the carbon dioxide gas permeability A and the nitrogen gas permeability B.

Theoretically, when two gas permeable bodies are disposed in series, the gas permeability of the upstream gas permeable body being defined as x and the gas permeability of the downstream gas permeable body being defined as y, the total gas permeability z of the combined two gas permeable bodies is considered to be represented by (Formula 4) below.

$$1 / z = 1 / x + 1 / y \qquad ( Formula 4 )$$

By rearranging (Formula 4), the following (Formula 5) is obtained.

$$z = ( xy ) / ( x + y ) \qquad ( Formula 5 )$$

The separation membrane 112 can be regarded as the upstream gas permeable body, and the porous plate 111 can be regarded as the downstream gas permeable body. Therefore, when the carbon dioxide gas permeability of the separation membrane unit 110 is defined as z1, the carbon dioxide gas permeability z1 of the separation membrane unit 110 is considered to be represented by the following (Formula 6) by combining the carbon dioxide gas permeability A of the separation membrane 112 and the gas permeability C of the porous plate 111.

$$z 1 = ( AC ) / ( A + C ) \qquad ( Formula 6 )$$

Similarly, when the nitrogen gas permeability of the separation membrane unit 110 is defined as z2, the nitrogen gas permeability z2 of the separation membrane unit 110 is considered to be represented by following (Formula 7).

$$z 2 = ( BC ) / ( B + C ) \qquad ( Formula 7 )$$

The selectivity ratio of the separation membrane unit 110 is defined as a. Based on (Formula 6) and (Formula 7), the selectivity ratio α of the separation membrane unit 110 is considered to be represented by (Formula 8) below.

$$z 1 / z 2 = \{ ( B + C ) / ( A + C ) \} \cdot ( A / B ) \qquad ( Formula 8 )$$

Based on (Formula 8), it is considered that the selectivity ratio α of the separation membrane unit 110 is obtained by multiplying the selectivity ratio A/B of the separation membrane 112 by (B+C)/(A+C). Therefore, (B+C)/(A+C) can be regarded as the magnification of the selectivity ratio.

Hereinafter, (B+C)/(A+C) is also referred to as the “magnification of the selectivity ratio (B+C)/(A+C)”. At the magnification of the selectivity ratio (B+C)/(A+C), the carbon dioxide gas permeability A and the nitrogen gas permeability B are determined by the performance of the separation membrane 112 to be incorporated into the separation membrane unit 110. The nitrogen gas permeability B is smaller than the carbon dioxide gas permeability A. Therefore, regardless of the value of the gas permeability C of the porous plate 111, the magnification of the selectivity ratio (B+C)/(A+C) must be less than 1. As the value of the gas permeability C of the porous plate 111 increases, the influence of the values of carbon dioxide gas permeability A and nitrogen gas permeability B is reduced, and the selectivity ratio (B+C)/(A+C) approaches 1.

Therefore, it can be seen that in order to increase the selectivity ratio α of the separation membrane unit 110, it is important to increase the gas permeability C of the porous plate 111. In addition, considering only the influence of the gas permeability C, when the porous plate 111 is designed so as to satisfy the following (Formula 9), it is considered that the selectivity ratio α of the separation membrane unit 110 can be less than 100% and 80% or more of the selectivity ratio A/B of the separation membrane 112.

$$1 > ( B + C ) / ( A + C ) \geq 0.8 \qquad ( Formula 9 )$$

However, in practice, even when the above (Formula 9) is satisfied, the selectivity ratio α of the separation membrane unit 110 may not necessarily reach 80% or more of the selectivity ratio A/B of the separation membrane 112, due to other factors such as insufficient depressurization of the pump 150. As described above, (B+C)/(A+C) is not necessarily the magnification of the selectivity ratio, but (B+C)/(A+C) is considered to have a constant correlation with the selectivity ratio α of the separation membrane unit 110.

The gas permeability C of the porous plate 111 can be increased by reducing the pressure loss in the porous plate 111. The pressure loss in the porous plate 111 can be adjusted, for example, by the average thickness T2 of the porous plate 111, the average diameter D1 of the plurality of through holes 111h, the opening ratio of the porous plate 111, the surface roughness of the porous plate 111, and the like. The smaller the average thickness T2 of the porous plate 111, the smaller the pressure loss. The larger the average diameter D1 of the plurality of through holes 111h, the smaller the pressure loss. The larger the opening ratio of the porous plate 111, the smaller the pressure loss. The smaller the surface roughness of the porous plate 111, the smaller the pressure loss.

As described above, damage to the separation membrane 112 can be suppressed when T1/D1≥0.02 is satisfied. However, the greater the average thickness T1 of the separation membrane 112, or the smaller the average diameter D1 of the plurality of through holes 111h, the lower the carbon dioxide gas permeability of the separation membrane unit 110. Therefore, it is preferable that 1.5≥T1/D1≥0.02, and more preferably 0.1≥T1/D1≥0.02.

As described above, the disclosers of the present application have clarified that it is important to consider both the T1/D1 and the gas permeability C of the porous plate 111 in order to improve the selectivity ratio α of the separation membrane unit 110 with respect to the selectivity ratio A/B of the separation membrane 112 while suppressing damage to the separation membrane 112.

Next, a method for designing the separation membrane unit 110, in light of the above, will be described.

The method for designing the separation membrane unit 110 includes selecting the separation membrane 112 and designing the porous plate 111. Hereinafter, each step will be described in detail.

In selecting the separation membrane 112, a membrane that satisfies 500,000 GPU≥A≥1,000 GPU and 200 μm≥T1≥10 μm is selected as the separation membrane 112 to be incorporated into the separation membrane unit 110.

In designing the porous plate 111, the porous plate 111 is designed so that T1/D1≥0.02 and 1>(B+C)/(A+C)≥0.8.

Thus, with reference to the average thickness T1, the carbon dioxide gas permeability A, and the nitrogen gas permeability B of the selected separation membrane 112, the values of the average diameter D1 and the gas permeability C that allow the separation membrane unit 110 to have a good selectivity ratio α while suppressing damage to the separation membrane 112 are clearly defined. Therefore, the separation membrane unit 110 becomes easier. As a result, while suppressing damage to the separation membrane 112, the separation membrane unit 110 having a good selectivity ratio α with respect to the selectivity ratio A/B of the separation membrane 112 can be easily obtained.

Next, the effects of the present embodiment will be described.

The separation membrane unit 110 according to the present embodiment is a separation membrane unit 110 that selectively separates carbon dioxide gas from a supply gas G1 containing carbon dioxide gas and nitrogen gas. The separation membrane unit 110 includes a porous plate 111 and a separation membrane 112. The porous plate 111 has a first surface 111a and a second surface 111b opposite to each other, and a plurality of through holes 111h extending from the first surface 111a toward the second surface 111b are formed. The separation membrane 112 includes a porous body 113 disposed on the first surface 111a and a resin layer 114 disposed on the porous body 113 and selectively permeating the carbon dioxide gas contained in the supply gas G1 toward the porous body 113. When the carbon dioxide gas permeability of the separation membrane 112 is defined as A, 500,000 GPU≥A≥1,000 GPU is satisfied. When the average thickness of the separation membrane 112 is defined as T1, 200 μm≥T1≥10 μm is satisfied. When the average diameter of the plurality of through holes 111h in the first surface 111a is defined as D1, T1/D1≥0.02 is satisfied. When the nitrogen gas permeability of the separation membrane 112 is defined as B and the gas permeability of the porous plate 111 is defined as C, 1>(B+C)/(A+C)≥0.8 is satisfied.

As described above, T1/D1≥0.02 is satisfied. Therefore, in a state in which the pressure applied to the surface 112a of the separation membrane 112, to which the supply gas G1 is supplied, is higher than the pressure applied to the surface 112b of the separation membrane 112 that is in contact with the porous plate 111, it is possible to suppress the separation membrane 112 from being damaged. Further, 1>(B+C)/(A+C)≥0.8 is satisfied. Therefore, the separation membrane unit 110 having a good selectivity ratio α with respect to the selectivity ratio A/B of the separation membrane 112 can be realized. That is, it is possible to achieve both the two effects of suppressing the damage to the separation membrane 112 and improving the selectivity ratio α of the separation membrane unit 110.

Further, 1.5≥T1/D1 is satisfied. Accordingly, it is possible to prevent the average thickness T1 of the separation membrane 112 from increasing excessively and to prevent the average diameter D1 of the plurality of through holes 111h in the porous plate 111 from decreasing excessively. As a result, the decrease in the carbon dioxide gas permeability of the separation membrane unit 110 can be suppressed.

Further, 5 mm≥D1≥0.1 mm is satisfied. By setting the average diameter D1 of the plurality of through holes 111h in the porous plate 111 to be equal to or less than the above upper limit value, the rigidity of the porous plate 111 can be improved. Accordingly, deformation of the porous plate 111 can be suppressed in a state where the pressure applied to the first surface 111a of the porous plate 111 is higher than the pressure applied to the second surface 111b. Further, by setting the average diameter D1 of the plurality of through holes 111h in the porous plate 111 to be equal to or greater than the above lower limit value, the gas permeability C of the porous plate 111 can be improved.

When the average thickness of the porous plate 111 is defined as T2, 30 mm≥T2≥0.05 mm is satisfied. By setting the average thickness T2 of the porous plate 111 to be equal to or less than the above upper limit value, the gas permeability C of the porous plate 111 can be improved. In addition, by setting the average thickness T2 of the porous plate 111 to be equal to or greater than the above lower limit value, the rigidity of the porous plate 111 can be improved. Accordingly, deformation of the porous plate 111 can be suppressed in a state where the pressure applied to the first surface 111a of the porous plate 111 is higher than the pressure applied to the second surface 111b.

The opening ratio of the porous plate 111 is 5% or more and 95% or less. By setting the opening ratio of the porous plate 111 to be equal to or greater than the above lower limit value, the gas permeability C of the porous plate 111 can be improved. By setting the opening ratio of the porous plate 111 to be equal to or less than the above upper limit value, the rigidity of the porous plate 111 can be improved. Accordingly, deformation of the porous plate 111 can be suppressed in a state where the pressure applied to the first surface 111a of the porous plate 111 is higher than the pressure applied to the second surface 111b.

A plurality of pores 113h are formed in the porous body 113, and the average diameter of the plurality of pores 113h is 5 nm or more and 1,000 nm or less. By setting the average diameter of the plurality of pores 113h of the porous body 113 to be equal to or greater than the above lower limit value, the carbon dioxide gas permeability of the porous body 113 can be improved. By setting the average diameter of the plurality of pores 113h of the porous body 113 to be equal to or less than the above upper limit value, the mechanical strength of the porous body 113 can be improved. Accordingly, the porous body 113 can favorably support the resin layer 114.

The porous plate 111 includes a metal material or a ceramic material. Accordingly, the rigidity of the porous plate 111 can be increased.

The resin layer 114 contains organopolysiloxane. Accordingly, the carbon dioxide gas permeability of the resin layer 114 can be increased.

The porous body 113 includes a polymer material, a ceramic material, or a metal material. When the porous body 113 contains a polymer material, the gas permeability of the porous body 113 can be increased. When the porous body 113 contains a ceramic material or a metal material, the mechanical strength of the porous body 113 can be increased.

The separation apparatus 100 according to the present embodiment is mounted with the separation membrane unit 110 described above. Therefore, it is possible to realize the separation apparatus 100 having a good selectivity ratio with respect to the selectivity ratio A/B of the separation membrane 112 while suppressing damage to the separation membrane 112.

### Modification 1

Next, a separation membrane unit 210 according to Modification 1 will be described.

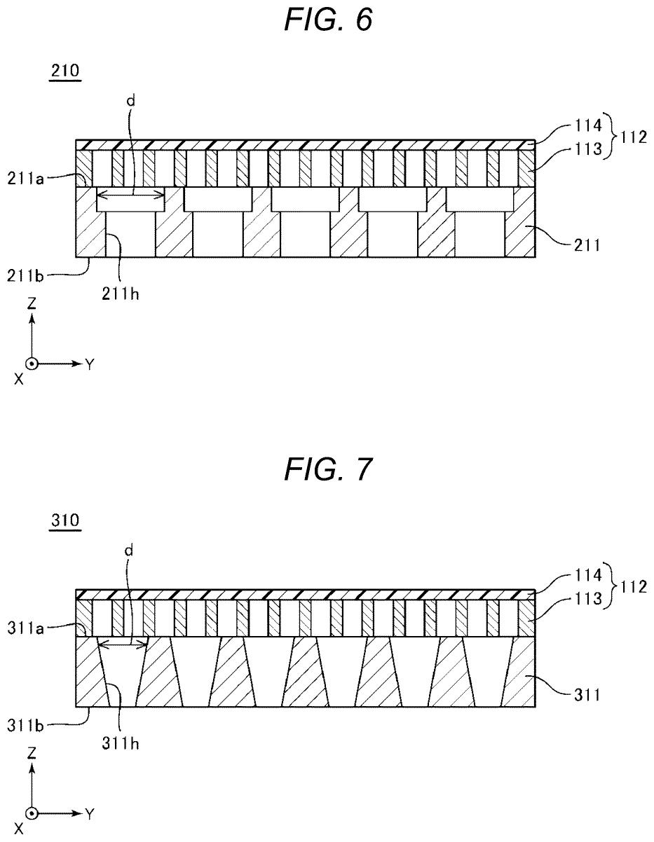

FIG. 6 is a cross-sectional view illustrating a separation membrane unit 210 according to the present modification.

The separation membrane unit 210 is different from the separation membrane unit 110 according to the above-described embodiment in the shape of the plurality of through holes 211h formed in the porous plate 211. Hereinafter, differences between the present modification and the embodiment will be mainly described, and descriptions of configurations similar to those of the embodiment will be appropriately omitted. The same applies to Modification 2 described later.

The porous plate 211 has a first surface 211a and a second surface 211b having a front-back relationship with each other. The separation membrane 112 is disposed on the first surface 211a. A plurality of through holes 211h extending from the first surface 211a toward the second surface 211b are formed in the porous plate 211.

The diameter d of each through hole 211h decreases stepwise in the direction from the first surface 211a toward the second surface 211b. This can increase the area where the separation membrane 112 is exposed from the porous plate 211. As a result, the carbon dioxide gas permeability of the separation membrane unit 210 can be increased. In addition, by stepwise decreasing the diameter d of each through hole 211h in the direction from the first surface 211a toward the second surface 211b, the solid portion of the porous plate 111 can be increased, and the rigidity of the porous plate 211 can be increased.

In the present modification, the diameter d of the through hole 211h changes once in a direction from the first surface 211a toward the second surface 211b, but may change twice or more.

### Modification 2

Next, a separation membrane unit 310 according to Modification 2 will be described.

FIG. 7 is a cross-sectional view illustrating a separation membrane unit 310 according to the present modification.

The separation membrane unit 310 is different from the separation membrane unit 110 according to the embodiment in the shape of the plurality of through holes 311h formed in the porous plate 311.

The porous plate 311 has a first surface 311a and a second surface 311b opposite to each other. The separation membrane 112 is disposed on the first surface 311a. A plurality of through holes 311h extending from the first surface 311a toward the second surface 311b are formed in the porous plate 311.

The diameter d of each through hole 311h continuously decreases in a direction from the first surface 311a toward the second surface 311b. In the present embodiment, each through hole 311h has a frustum shape. Even with such a configuration, the same effect as that of the separation membrane unit 210 according to Modification 1 can be obtained. It should be noted that “the diameter d continuously decreases” does not strictly mean that the diameter d gradually decreases, but allows for the surface roughness of the surface on which the through hole 311h is formed due to the manufacturing accuracy of the porous plate 111 or the like.

### EXAMPLE

Then, examples will be described.

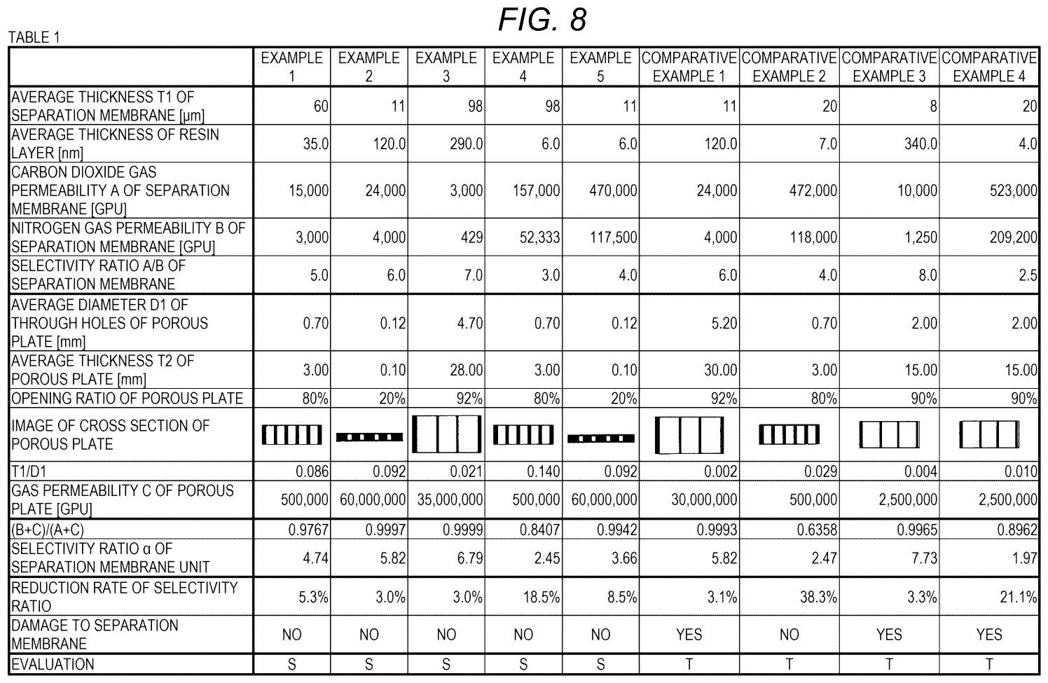

FIG. 8 is Table 1 showing the configurations and evaluation results of the separation membrane units of Examples 1 to 5 and the separation membrane units of Comparative Examples 1 to 4.

First, whether the separation membrane was damaged depending on the value of T1/D1 and how the selectivity ratio of the separation membrane unit changed depending on the structure of the porous plate were examined. Details will be described below.

As illustrated in Table 1, the separation membrane units according to Examples 1 to 5 and Comparative Examples 1 to 4 were prepared. Each separation membrane unit includes a porous plate and a separation membrane.

A method for preparing each separation membrane will be described. First, an organopolysiloxane was deposited, by a plasma polymerization method, on one surface of a porous body made of alumina (Al₂O₃). Thus, a separation membrane, which is a composite membrane of the porous body and the resin layer, was obtained. Octamethyltrisiloxane was used as a raw material gas, and a constituent material of the obtained resin layer was an organopolysiloxane. The average diameter of the pores of the porous body was 100 nm, and the porosity was about 50%. The average thickness T1 of the separation membrane and the average thickness of the resin layer in each Example and each Comparative Example were measured by SEM. Results are shown in Table 1.

The carbon dioxide gas permeability A and the nitrogen gas permeability B of each separation membrane were measured using the gas permeability measuring apparatus 10. When measuring the carbon dioxide gas permeability A of each separation membrane, the gas supply unit 11 was set to supply carbon dioxide gas as a single gas. When measuring the nitrogen gas permeability B of each separation membrane, the gas supply unit 11 was set to supply nitrogen gas as a single gas. Then, the selectivity ratio A/B of each separation membrane was calculated from the carbon dioxide gas permeability A and the nitrogen gas permeability B. Results are shown in Table 1.

A punching metal made of stainless steel was used for each porous plate. The average diameter D1 of the plurality of through holes in each porous plate was measured with a caliper or a measurement microscope. The average thickness T2 of each porous plate was measured with a caliper. The shape of each through hole was a cylindrical shape, the same as in the embodiment. The opening ratio of the porous plate was calculated from the total area of the average diameter D1 of the plurality of through holes. Further, T1/D1 was calculated from the average thickness T1 of the separation membrane and the average diameter D1 of the plurality of through holes. Results are shown in Table 1.

The gas permeability C of each porous plate was measured using the gas permeability measuring apparatus 10. When measuring the gas permeability C of each porous plate, the gas supply unit 11 was set to supply nitrogen gas as a single gas. (B+C)/(A+C) was calculated from the carbon dioxide gas permeability A, the nitrogen gas permeability B, and the gas permeability C. Results are shown in Table 1.

Next, each of the prepared separation membranes was disposed on each porous plate. The carbon dioxide gas permeability and the nitrogen gas permeability of each separation membrane unit were measured using the gas permeability measuring apparatus 10. At this time, the gas supplied by the gas supply unit 11 was a mixed gas of carbon dioxide gas and nitrogen gas. The concentration of carbon dioxide gas was set to 400 ppm. The test temperature was set to 20° C. The selectivity ratio α of the separation membrane unit was calculated from the measured carbon dioxide gas permeability and nitrogen gas permeability. The reduction rate of the selectivity ratio α of the separation membrane unit to the selectivity A/B of the separation membrane was calculated. The presence or absence of damage to the separation membrane at this time was confirmed by SEM. Then, the separation membrane unit was evaluated according to the following evaluation criteria. Results are shown in Table 1.
S: The separation membrane is not damaged and the reduction rate of the selectivity ratio is 20% or less.
T: The separation membrane is damaged or the reduction rate of the selectivity ratio exceeds 20%.

In the separation membrane units according to Examples 1 to 5, T1/D1≥0.02 was satisfied in all cases, and no damage to the separation membranes was observed. In the separation membrane units according to Examples 1 to 5, (B+C)/(A+C)≥0.8 was satisfied, and the reduction rate of the selectivity ratio was 20% or less. Therefore, while suppressing damage to the separation membrane, the separation membrane unit having a good selectivity ratio α with respect to the selectivity ratio A/B of the separation membrane was realized.

Among the porous plates of Examples 1 to 5, the porous plates of Examples 2 and 5 had the highest gas permeability C. In the porous plates of Examples 2 and 5, although the average diameter D1 of the plurality of through holes and the opening ratio are smaller, and the average thickness T2 of the porous plate is smaller than those of the porous plates of Examples 1, 3, and 4. Therefore, it was found that it is particularly effective to reduce the average thickness T2 of the porous plate in order to increase the gas permeability C.

In the separation membrane unit according to Comparative Example 1, 0.02>T1/D1 was satisfied, and damage to the separation membrane was observed. The average thickness T1 of the separation membrane of Comparative Example 1 is substantially the same as the average thickness T1 of the separation membrane of Example 2, but the average diameter D1 of the plurality of through holes in the porous plate of Comparative Example 1 is larger than the average diameter D1 of the plurality of through holes in the porous plate of Example 2. In Comparative Example 1, the separation membrane deflected downward into the through hole in the porous plate. Therefore, in Comparative Example 1, it is considered that the average diameter D1 of the plurality of through holes in the porous plate was too large with respect to the average thickness T1 of the separation membrane, causing increased deflection and resulting in damage to the separation membrane.

In the separation membrane unit according to Comparative Example 2, T1/D1≥0.02 was satisfied, and damage to the separation membrane was not observed. However, 0.8≥(B+C)/(A+C) was satisfied, and the reduction rate of the selectivity ratio exceeded 20%. The porous plate of Comparative Example 2 is the same as the porous plate of Example 1, and the gas permeability C is the same. However, the carbon dioxide gas permeability A and the nitrogen gas permeability B of the separation membrane of Comparative Example 2 are higher than the carbon dioxide gas permeability A and the nitrogen gas permeability B of the separation membrane of Example 1. Therefore, even when the same porous plate was used, in Comparative Example 2, the gas permeability C of the porous plate was not sufficient, and (B+C)/(A+C) decreased. As a result, it is considered that the reduction rate of the selectivity ratio exceeded 20%.

In the separation membrane unit according to Comparative Example 3, the separation membrane was not self-standing and damaged. The reason for this is considered to be that although the average thickness T1 of the separation membrane was 8 μm, which was smaller than those of Examples 1 to 5, the average thickness of the resin layer was too large, and the porous body could not support the resin layer and the separation membrane was damaged. In Examples 1 to 5, the average thickness T1 of the separation membrane was 10 μm or more, and the self-standing property of the separation membrane could be ensured even when the average thickness of the resin layer was increased. Therefore, in order to ensure the self-standing property of the separation membrane irrespective of the average thickness of the resin layer, it is considered preferable that the thickness of the separation membrane be 10 μm or more.

In the separation membrane unit according to Comparative Example 4, A>500,000 GPU was satisfied. In such a separation membrane, the reduction rate of the selectivity ratio exceeded 20%. The reason for this is considered to be that, when the carbon dioxide gas permeability A of the separation membrane was too high, the concentration of carbon dioxide gas immediately above the separation membrane decreased, resulting in a decrease in the carbon dioxide gas permeability of the separation membrane unit. Therefore, it is preferable that 500,000 GPU≥A.

The selectivity ratios α of the separation membrane units of Examples 1 to 5 and Comparative Examples 1 to 4 shown in the table were the values obtained by the experiment as described above, and showed substantially the same tendency as in the theoretical formula (Formula 8). Therefore, it was confirmed that it was appropriate to design the porous plate using (B+C)/(A+C).

In summary, it was found that when 500000 GPU≥A≥1,000 GPU, 200 μm≥T1≥10 μm, T1/D1≥0.02, and 1>(B+C)/(A+C)≥0.8 were satisfied, it is possible to realize a separation membrane unit having a good selectivity ratio α with respect to the selectivity ratio A/B of the separation membrane while suppressing damage to the separation membrane.

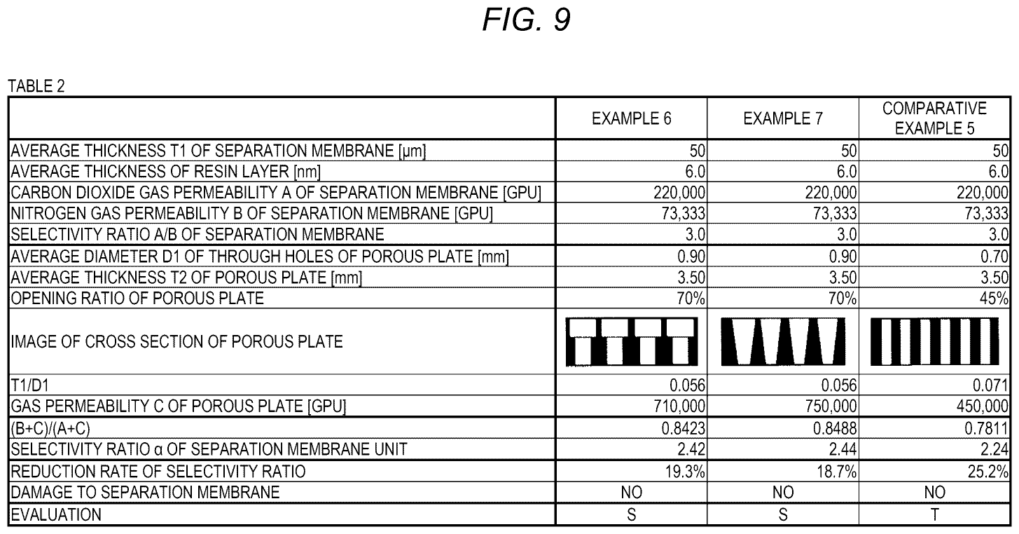

FIG. 9 is a Table 2 showing the configurations and evaluation results of the separation membrane unit of Examples 6 and 7, and Comparative Example 5.

Next, whether the separation membrane was damaged depending on the shape of the through holes in a porous plate and how the selectivity ratio of the separation membrane unit changed depending on the shape of the through hole in the porous plate were examined. Details will be described below.

First, the separation membrane units according to Examples 6 and 7, and Comparative Example 5 were prepared. Each separation membrane unit includes a porous plate and a separation membrane. Since the method for preparing each separation membrane is the same as the method described above, the description thereof will be omitted. The material of each porous plate is a punching metal made of stainless steel.

The shape of each through hole in the porous plate of Example 6 was the same as the shape of the through hole in the porous plate of Modification 1. In other words, the diameter of each through hole was designed to decrease stepwise in the direction from the separation membrane toward the porous plate.

The shape of each through hole in the porous plate of Example 7 was the same as the shape of the through hole in the porous plate of Modification 2. In other words, the diameter of each through hole was designed to decrease continuously in the direction from the separation membrane toward the porous plate.

The shape of each through hole in the porous plate of Comparative Example 5 was such that the diameter of each through hole remained substantially constant without changing in the direction from the separation membrane toward the porous plate.

The average thickness T1 of the separation membrane, the average thickness of the resin layer, the carbon dioxide gas permeability A of the separation membrane, the nitrogen gas permeability B of the separation membrane, and the selectivity ratio A/B of the separation membrane were determined in the same manner as described above. Furthermore, the average diameter D1 of the through holes in the first surface of the porous plate, the average thickness T2 of the porous plate, the opening ratio of the porous plate, T1/D1, and the gas permeability C of the porous plate were determined in the same manner as described above. In addition, (B+C)/(A+C), the selectivity ratio α of the separation membrane unit, and the reduction rate of the selectivity ratio were determined in the same manner as described above. The presence or absence of damage to the separation membrane was examined in the same manner as described above. Results are shown in Table 2.

In Examples 6 and 7, T1/D1≥0.02 was satisfied, and no damage to the separation membrane was observed. Therefore, it was found that the evaluation method using T1/D1≥0.02 can be applied to the porous plate in which the shape of the through hole changes in the thickness direction of the porous plate as in Examples 6 and 7.

In Examples 6 and 7, 1>(B+C)/(A+C)≥0.8 was satisfied, and the reduction rate of the selectivity was 20% or less. Therefore, it was found that the gas permeability C can be sufficiently ensured even in the porous plate in which the shape of the through holes changes in the thickness direction of the porous plate as in Examples 6 and 7. Since the gas permeability C of the porous plate of: Example 7 was higher than the gas permeability C of the porous plate of Example 6, it was found that the gas permeability C was further increased by continuously changing the diameter of the through hole.

In Comparative Example 5, T1/D1≥0.02 was satisfied, and no damage of the separation membrane was observed. However, 0.8>(B+C)/(A+C) was satisfied, and the reduction rate of the selectivity ratio exceeded 20%. The reason for this is considered to be that, the gas permeability C of the porous plate of Comparative Example 5 was lower than the gas permeability C of the porous plates of Examples 6 and 7.

Although the separation membrane unit and the separation apparatus according to the present disclosure are described above based on the illustrated embodiments and the plurality of modifications, the present disclosure is not limited thereto.

For example, the separation membrane unit and the separation apparatus according to the present disclosure may be those in which each part of the above-described embodiments and modifications is replaced with a component having substantially the same function, or to which any component is added.

What is claimed is:

1. A separation membrane unit that selectively separates carbon dioxide gas from a supply gas containing the carbon dioxide gas and nitrogen gas, the separation membrane unit comprising:
a porous plate having a first surface and a second surface opposite to each other, and in which a plurality of through holes extending from the first surface toward the second surface are formed;
and a separation membrane including a porous body disposed on the first surface and a resin layer disposed on the porous body and selectively permeating the carbon dioxide gas contained in the supply gas toward the porous body,
wherein when the carbon dioxide gas permeability of the separation membrane is defined as A, 500,000 GPU≥A≥1,000 GPU is satisfied,
when the average thickness of the separation membrane is defined as T1, 200 μm≥T1≥10 μm is satisfied;
when the average diameter of the plurality of through holes on the first surface is D1, T1/D1≥0.02 is satisfied, and
when the nitrogen gas permeability of the separation membrane is defined as B and the gas permeability of the porous plate is defined as C, 1>(B+C)/(A+C)≥0.8 is satisfied.

2. The separation membrane unit according to claim 1, wherein 1.5≥T1/D1 is satisfied.

3. The separation membrane unit according to claim 1, wherein 5 mm≥D1≥0.1 mm is satisfied.

4. The separation membrane unit according to claim 1, wherein when the average thickness of the porous plate is defined as T2, 30 mm≥T2≥0.05 mm is satisfied.

5. The separation membrane unit according to claim 1, wherein an opening ratio of the porous plate is 5% or more and 95% or less.

6. The separation membrane unit according to claim 1, wherein a diameter of the through hole decreases continuously or stepwise in a direction from the first surface toward the second surface.

7. The separation membrane unit according to claim 1,
wherein a plurality of pores are formed in the porous body, and an average diameter of the plurality of pores is 5 nm or more and 1,000 nm or less.

8. The separation membrane unit according to claim 1, wherein the porous plate contains a metal material or a ceramic material.

9. The separation membrane unit according to claim 1, wherein the resin layer contains an organopolysiloxane.

10. The separation membrane unit according to claim 1, wherein the porous body contains a polymer material, a ceramic material, or a metal material.

11. A separation apparatus mounted with the separation membrane unit according to claim 1.
